(19) United States
(12) Patent Application Publication
(10) Pub. No.: US 2025/0162443 A1
(43) Pub. Date: May 22, 2025

(54) Power Energy Scheduling Optimization Method and System for User-side Energy Storage Sharing Framework

(71) Applicant: State Grid Nanjing Power Supply Company, Nanjing (CN)

(72) Inventors: Hai Qing GAN, Nanjing (CN); Yucheng REN, Nanjing (CN); Hangtong ZHANG, Nanjing (CN); Kun CHEN, Nanjing (CN); Baligen TALIHATI, Nanjing (CN); Yu WANG, Nanjing (CN); Nan YANG, Nanjing (CN); Jie SONG, Nanjing (CN); Yaojie SUN, Nanjing (CN)

(73) Assignee: State Grid Nanjing Power Supply Company, Nanjing (CN)

(21) Appl. No.: 18/641,379

(22) Filed: Apr. 21, 2024

(30) Foreign Application Priority Data
Nov. 20, 2023 (CN) 202311546748.7

(51) Int. Cl. B60L 53/64; B60L 53/51; B60L 53/62; B60L 53/63; B60L 58/14; H02J 3/14; H02J 3/32; H02J 3/38; H02J 7/00

(52) U.S. Cl. CPC B60L 53/64; B60L 53/51; B60L 53/62; B60L 53/63; B60L 58/14; H02J 3/144; H02J 3/32; H02J 3/38; H02J 7/0048; H02J 7/0063; H02J 7/00712; H02J 2203/20

(57) ABSTRACT

The invention relates to a system for a user-side energy storage sharing framework. A power energy scheduling optimization method comprises: establishing a user load model, an energy storage battery model and a user-to-user capacity sharing model; with a minimum electricity cost of a whole community as an objective optimization function, resolving optimal scheduling based on the function using a MILP algorithm as an optimization technique for power energy scheduling of a user-side energy storage sharing framework; and performing power energy scheduling for users according to a resolved result. The invention determines a user cost model under the user-side energy storage sharing framework, establishes an electricity model of non-transferable loads and transferable loads and corresponding constraints, and obtains optimal values of adjustable variables to control electricity consumed by electric loads by resolving an optimal value of an objective function under the precondition of reducing user costs, thus further reducing electricity costs.

### BACKGROUND OF THE INVENTION

### 1. Technical Field

The application relates to the technical field of electric engineering, in particular to a power energy scheduling optimization method and system for a user-side energy storage sharing framework.

### 2. Description of Related Art

With the rapid development of renewable energy, the application of energy storage techniques in the energy field attracts more and more attention. Under this background, the concept of energy storage sharing becomes a promising solution. Existing energy systems face the challenges of low allocation rate of energy storage and high configuration cost of energy storage, which become prominent gradually. In view of this, energy storage sharing, as a novel energy management mode, attract tremendous attention. The core concept of energy storage sharing is to realize energy sharing and coordination between multiple users and more flexibly satisfy diversified energy requirements by integrated distributed energy resources so as to reduce the overall energy consumption and improve the efficiency of energy systems. Such an innovative energy storage technique has a remarkable potential and is expected to promote wide application of renewable energy in the energy field to make a contribution to realizing the goal of sustainable energy supply. Energy storage sharing involves multiple users, energy supplies and loads, leading to complex power energy scheduling of energy storage sharing. The difficulty in finding an optimal power energy scheduling scheme restrains cost optimization of the energy storage sharing system.

### BRIEF SUMMARY OF THE INVENTION

The application provides a power energy scheduling optimization method and system for a user-side energy storage sharing framework, which can determine a user cost model under the user-side energy storage sharing framework to optimize a user-to-user power energy scheduling scheme under the precondition of reducing user costs, thus further reducing electricity costs.

The technical solution of the application is as follows:

A power energy scheduling optimization method for a user-side energy storage sharing framework comprises the following steps:
establishing an electricity cost model of a whole community as an objective optimization function, and setting constraints of the electricity cost model; and
resolving optimal values of variables in the electricity cost model, and controlling electric devices according to the optimal values.

Further, the community includes multiple users, the users have different types of loads and are provided with solar power generation devices and battery energy storage devices, and capacity sharing is allowed between the battery energy storage devices of the users.

Further, a formula of the objective optimization function is:

$$min {\sum }_{t ∈ T} {\prod }_{t} Δ {TP}_{t} \qquad ( 1 )$$

where, Πₜ is a real-time electricity price, ΔT is a time interval, which is defined as 1 h here, Pₜ is a total power of the community at a time t, and T={1, . . . , 24} is a cycle of optimal scheduling, which is 24 hrs of one day here; the objective optimization function aims to calculate a minimum value of a total cost of the whole community within the cycle of optimal scheduling;
the total power of the community under the user-side energy storage sharing framework is expressed as:

$${P}_{t} = {\sum }_{r ∈ R} {P}_{r , t} \qquad ( 2 )$$

$${P}^{min} \leq {P}_{t} \leq {P}^{max} \qquad ( 3 )$$

where, P_{r,t} is a power of a r^{th} residence in the community, R is the number of residences in the community, and due to physical constraints, the power of the residence has an upper limit and a lower limit, and P^{max} and P^{min} are the upper limit and the lower limit of the power of the residence respectively;
the power of the residence under the user-side energy storage sharing framework is expressed as:

$${P}_{r , t} = {\sum }_{d ∈ D} {P}_{d , t} - {P}_{r}^{i n} + {P}_{r}^{out} + {C}_{d , t} - {G}_{d , t} \qquad ( 4 )$$

$${P}_{r}^{min} \leq {P}_{r , t} \leq {P}_{r}^{max} \qquad ( 5 )$$

where, P_{d,t} is a power of a d^{th} electric appliance in the residence, including transferable loads, non-transferable loads, temperature control device loads and energy storage loads in the residence, and d∈D, wherein D is a set of electric appliances; G_{d,t} is a generated power of the residence, which refers to a solar generated power here; C_{d,t} is a basic load of electric appliances other than the transferable loads, the non-transferable loads, the temperature control device loads and the energy storage loads in the residence; due to physical constraints, the power of the residence is limited by formula (5); Pᵣⁱⁿ is an input shared power, and Pᵣ^{out} is an output shared power.

Further, the transferable loads in the residence are delayable loads which are flexibly adjustable during peak power demand, and the transferable loads include an electric vehicle EV, and a model of the electric vehicle EV is expressed as:

$${S}_{d , t + 1}^{e v} = {S}_{d , t}^{e v} + {P}_{d , t} Δ T \qquad ( 6 )$$

$${p}_{dod} {S}_{max}^{e v} \leq {S}_{d , t}^{e v} \leq {S}_{max}^{e v} \qquad ( 7 )$$

$${e}_{d , t} {P}_{min}^{e v} \leq {P}_{d , t} \leq {e}_{d , t} {P}_{max}^{e v} \qquad ( 8 )$$

$${e}_{d , t} ∈ \{ 0 , 1 \} \qquad ( 9 )$$

$${S}_{d , 19}^{e v} \leq {p}_{st} {S}_{max}^{e v} \qquad ( 10 )$$

$${S}_{d , 7}^{e v} \geq {p}_{e d} {S}_{max}^{e v} \qquad ( 11 )$$

where, S_{d,t}^{ev} is an energy level of the electric vehicle EV, which is determined by a charge power per hour; formula (7) defines a charging constraint of the electric vehicle EV, p_{dod} is a deep discharge proportion of a battery, which is configured to ensure a good condition and life of the battery to prevent complete discharge of the battery; Sₘₐₓ^{ev} is a maximum capacity of the electric vehicle; formula (8) defines a constraint of the charge power; e_{d,t} is a variable, which is configured to determine whether the electric vehicle EV is charging or not; if e_{d,t} is 1, it indicates that the electric vehicle EV is charging; if e_{d,t} is 0, it indicates that the electric vehicle EV is not charging; pₛₜ and p_{ed} in formula (10) and formula (11) are state constraint proportions at specific times (19:00 and 7:00); it is stipulated that the electric vehicle EV starts to be charged when the capacity of the electric vehicle EV is less than or equal to pₛₜSₘₐₓ^{ev} and stops being charged when the capacity of the electric vehicle EV is greater than or equal to pₛₜSₘₐₓ^{ev}; it is specified that the electric vehicle EV should be charged from 19:00 to 7:00 of the next day, during which a charging state and number of electric vehicles EV are allowed to be adjusted according to power demand.

Further, the non-transferable loads in the residence are loads that cannot be interrupted or stopped once started;
the non-transferable loads are expressed as:

$${P}_{d , t} = {\sum }_{k = 0}^{L - 1} {u}_{d , t - k} {\tilde{P}}_{d , k} \qquad ( 12 )$$

$${\sum }_{t = 0}^{T - L} {u}_{d , t} = 1 \qquad ( 13 )$$

$${u}_{d , t} ∈ \{ 0 , 1 \} \qquad ( 14 )$$

where, in formula (12), P_{d,t} is a total power consumed by all the non-interruptible loads, and L is a running window of the non-transferable loads, that is, the non-transferable loads are allowed to run at a power \tilde{P}_{d,k} in each time period k [0, L−1]; formula (13) and formula (18) indicate that the non-transferable loads are non-interruptible in specified running times; u_{d,t} is 0 or 1 and is configured as a constraint for determining whether the loads are running; if u_{d,t} is 1, it indicates that the loads are running; if u_{d,t} is 0, it indicates that loads are not running.

Further, the temperature control device loads are loads of household appliances for controlling an indoor temperature, and a model of the temperature control device loads is expressed as:

$${ϑ}_{d , t + 1} = {a}_{d} {ϑ}_{d , t} + ( 1 - {a}_{d} ) ( {ϑ}_{d , t}^{e n v} - {ϑ}_{d , t}^{m} ) \qquad ( 15 )$$

$${a}_{d} = {e}^{- Δ T / {C}_{d} {R}_{d}} \qquad ( 16 )$$

$${ϑ}_{d , t}^{m} = {R}_{d} {P}_{d , t}^{tran} \qquad ( 17 )$$

$${P}_{d , t} = \frac{\vert {P}_{d , t}^{tran} \vert}{{η}_{tran}} \qquad ( 18 )$$

$${m}_{d , t} {P}_{d}^{min} \leq {P}_{d , t} \leq {m}_{d , t} {P}_{d}^{max} \qquad ( 19 )$$

$${m}_{d , t} ∈ \{ 0 , 1 \} \qquad ( 20 )$$

$${ϑ}_{d}^{min} \leq {ϑ}_{d , t} \leq {ϑ}_{d}^{max} \qquad ( 21 )$$

where, in formulas (15)-(21), formula (15) defines a temperature control model, wherein θ_{d,t} is an indoor temperature at the time t, which has a range defined by formula (21); a_{d} is a constant determined by formula (16), R_{d} is a heat resistance, indicating the degree of resistance against heat transfer of building materials; C_{d} is a heat capacity, indicating a heat storage capacity of the building materials; in formula (17), θ_{d,t}^{m} is a heat gain, specifically indicating heat provided by a temperature control device for an indoor space or heat absorbed by the temperature control device; P_{d,t}^{tran} is energy transfer efficiency, describing electric energy-to-heat energy efficiency of the temperature control device; in formula (18), ηₜᵣₐₙ is a performance coefficient, which is typically a parameter for describing the efficiency of a temperature control device system and is specifically described as a ratio of heat energy output by the system to electric energy consumed, and if the performance coefficient is greater than 1, it indicates that the system absorbs extra heat energy from the outside; P_{d,t} is power consumption of temperature control, indicating electric energy consumed by the temperature control device at the time t; formula (19) defines a range of P_{d,t}; m_{d,t} is a parameter configured to control the temperature control process; if m_{d,t} is 1, it indicates that temperature control is needed; if m_{d,t} is 0, it indicates that temperature control is not needed.

Further, an energy storage device is responsible for obtaining electric energy from a power grid or solar energy and storing the electric energy; then, the electric energy stored in the energy storage device is used for supplying power to the loads, and a model of the energy storage device is expressed as:

$${S}_{d , t + 1} = {S}_{d , t} + ( {η}_{c h}^{e} {P}_{d , t}^{c h} - \frac{{P}_{d , t}^{d i s}}{{η}_{d i s}^{e}} ) Δ T \qquad ( 22 )$$

$${S}_{d}^{min} \leq {S}_{d , t} \leq {S}_{d}^{max} \qquad ( 23 )$$

$${P}_{d , t} = {P}_{d , t}^{c h} - {P}_{d , t}^{d i s} \qquad ( 24 )$$

$${s}_{t}^{c h} {P}_{d , t}^{ch , min} \leq {P}_{d , t}^{c h} \leq {s}_{t}^{c h} {P}_{d , t}^{ch , max} \qquad ( 25 )$$

$${s}_{t}^{d i s} {P}_{d , t}^{dis , min} \leq {P}_{d , t}^{d i s} \leq {s}_{t}^{d i s} {P}_{d , t}^{dis , max} \qquad ( 26 )$$

$${s}_{t}^{c h} + {s}_{t}^{d i s} \leq 1 \qquad ( 27 )$$

$${s}_{t}^{c h} , {s}_{t}^{d i s} ∈ \{ 0 , 1 \} \qquad ( 28 )$$

$${S}_{d , 24} = {η}_{s} {S}_{d}^{max} \qquad ( 29 )$$

where, formula (22) defines a SOC of the battery at the time t, which is expressed as S_{d,t}; η_{ch}^{e} and η_{dis}^{e} are variables which respectively denote charging efficiency and discharging efficiency, P_{d,t}^{ch} and P_{d,t}^{dis} denote a charge power and a discharge power; permissible ranges of the variables are defined by formula (23), formula (25) and formula (26); in addition, formula (24) is used for calculating a net power obtained by the residence through energy storage; to ensure proper running, formula (27) and formula (28) compulsorily specify that a charging process and a discharging process of energy storage should not be performed synchronously; specifically, sₜ^{ch} is a bivariate; when sₜ^{ch} is 1, it indicates that a charging behavior is started; when sₜ^{ch} is 0, it indicates that the charging behavior is not performed; sₜ^{dis} is a bivariate for controlling a discharging behavior; if sₜ^{dis} is 1, it indicates that the discharging behavior is started; when sₜ^{dis} is 1, it indicates that the discharging behavior is not performed; in addition, formula (29) sets a specific final SOC for a last period of time to allow charging and discharging in the next day, wherein ηₛ is a proportional parameter for starting the energy storage device in the next day; and the power S_{d,24} of the energy storage device at a last time on a day is specified to be equal to ηₛS_{d}^{max} to ensure that the energy storage device can be started in the next day.

Further, an energy sharing model of the user-side energy storage sharing framework is expressed as:

$${\sum }_{r ∈ R} {P}_{r , t}^{i n} = {\sum }_{r ∈ R} {P}_{r , t}^{out} \qquad ( 30 )$$

$${P}_{r , t}^{i n} , {P}_{r , t}^{out} \geq {P}_{s h}^{min} \qquad ( 31 )$$

where, formula (30) defines a basic constraint of a capacity sharing process under the user-side energy storage sharing framework and ensures that total energy participating in household sharing matches total energy obtained by households; Pₛₕ^{min} in formula (31) is a minimum value of an energy sharing power, which is generally set to 0 and indicates that the energy sharing power should not be a negative value.

Further, the objective optimization function is resolved by a MILP algorithm.

In the other aspect, the application provides a power energy scheduling optimization system for a user-side energy storage sharing framework, comprising:
a modeling unit configured to store the electricity cost model of the whole community and the constraints in the power energy scheduling optimization method for a user-side energy storage sharing framework according to any one of claims 1-9;
a calculation unit configured to resolve an optimal value of the electricity cost model by a MILP algorithm; and
a control unit configured to control loads of households in the community according to the optimal value obtained by the calculation unit.

To sum up, the application has the following beneficial effects: the application determines a user cost model under the user-side energy storage sharing framework, establishes an electricity model of non-transferable loads and transferable loads and corresponding constraints, and obtains optimal values of adjustable variables to control electricity consumed by electric loads by resolving an optimal value of an objective function under the precondition of reducing user costs, thus further reducing electricity costs.

### BRIEF DESCRIPTION OF THE SEVERAL VIEWS OF THE DRAWINGS

FIG. 1 is a schematic diagram of a user-side energy storage sharing framework according to the invention, wherein each user is delineated by the dotted box, a basic load, a solar power generation device and an energy storage system are configured for each user in the dotted box, and the users can share energy resources;

FIG. 2 is a schematic diagram of the charge power of users in summer according to a specific implementation of the application;

FIG. 3 is a schematic diagram of the discharge power of users in summer according to a specific implementation of the application;

FIG. 4 is a schematic diagram of the SOC of batteries of users in summer according to a specific implementation of the application;

FIG. 5 is a schematic diagram of the charge power of users in winter according to a specific implementation of the application;

FIG. 6 is a schematic diagram of the discharge power of users in winter according to a specific implementation of the application;

FIG. 7 is a schematic diagram of the SOC of batteries of users in winter according to a specific implementation of the application;

FIG. 8 is a curve chart of capacity exchange of the user-side energy storage sharing framework in summer according to a specific implementation of the application;

FIG. 9 is a curve chart of capacity exchange of the user-side energy storage sharing framework in winter according to a specific implementation of the application.

### DETAILED DESCRIPTION OF THE INVENTION

Specific implementations of the application will be described in detail below in conjunction with accompanying drawings.

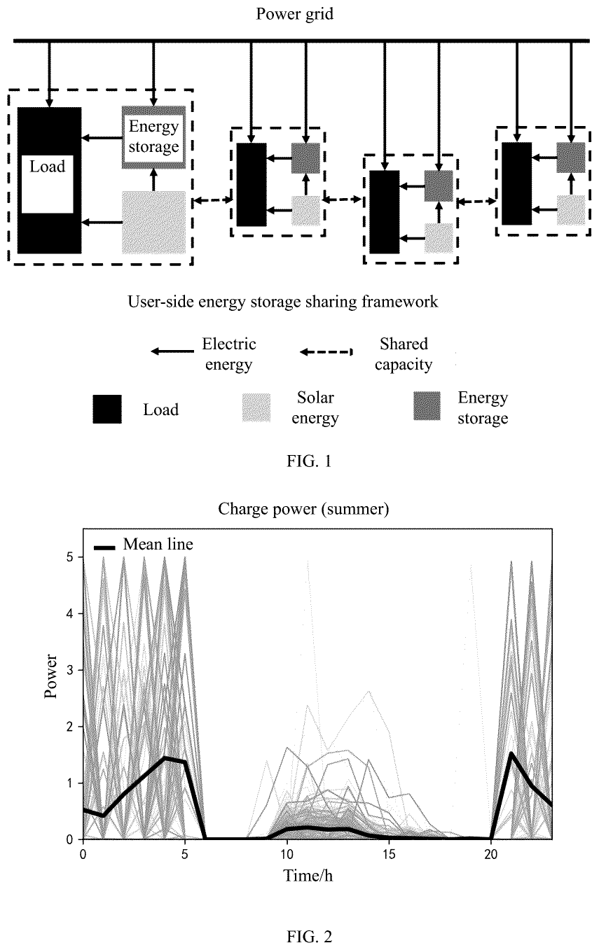

Embodiment: A power energy scheduling optimization method for a user-side energy storage sharing framework comprises the following steps:
establishing an electricity cost model of a whole community as an objective optimization function, and setting constraints of the electricity cost model, wherein as shown in FIG. 1, the community includes multiple users, the users have different loads and are provided with solar power generation devices and battery energy storage devices, and capacity sharing is allowed between the battery energy storage devices of the users; and resolving optimal values of variables in the electricity cost model, and controlling electric devices according to the optimal values.

In the objective optimization function, parameters and variables are defined as follows:

Πₜ: real-time electricity price, which reflects a price fluctuation of the power market.

ΔT: time interval, which is defined as 1 h here, corresponding to 24 hrs of one day.

Pₜ: total power of the community at a time t, which reflects power demand and supply of the community.

T: cycle of optimal scheduling, which is 24 hrs of one day.

The objective optimization function mainly aims to calculate a minimum value of a total cost of the whole community in one day, and power scheduling of the community is optimized by taking into changes in electricity price and power.

The following controllable variables (variables that can be controlled by the sharing framework) can be adjusted by an MILP algorithm to optimize the benefits of the sharing framework:

Pt: a total power of the community, which is composed of powers of all residences in the community and includes transferable loads, non-transferable loads, temperature control device loads and energy storage loads.

Pᵣⁱⁿ and Pᵣ^{out}: input shared power and output shared power of the residence respectively.

S_{d,t}^{ev}: energy level of an electric vehicle.

u_{d,t}: binary variable indicating whether the non-transferable loads run at a specific time.

θ_{d,t}: indoor temperature.

These controllable variables can be adjusted by an optimization process of the MILP algorithm to realize optimal scheduling of a power system to optimize benefits, including cost reduction, efficient running of the power system, integration of renewable energy sources, efficient management of the battery life, and optimization of energy storage sharing of the community.

In addition to the controllable variables, some certain variables not controlled by the framework are as follows:

Πₜ: real-time electricity price, which is an external parameter of the power market and is not directly controlled by the sharing framework. Πₜ has no influence on the cost element in the objective optimization function because the fluctuation of the electricity price will impact the running strategy of the power system.

ΔT: time interval, the definition of which is certain in the sharing framework and which is generally set as 1 h. ΔT has an influence on the cost element in the objective optimization function because it is related to the time accumulation of the power cost.

R_{d}: heat resistance of the residence, C_{d}: heat capacity of the residence, and ηₜᵣₐₙ: energy transfer efficiency, and the like; all these parameters are used for describing the performance and energy transfer efficiency of a temperature control device, are not directly controlled by the sharing framework, and are related to constraints of a temperature control model and energy transfer efficiency.

A formula of the objective optimization function is:

$$min {\sum }_{t ∈ T} {\prod }_{t} Δ {TP}_{t} \qquad ( 1 )$$

where, Πₜ is the real-time electricity price, ΔT is the time interval, which is defined as 1 h here, Pₜ is a total power of the community at a time t, and T={1, . . . , 24} is the cycle of optimal scheduling, which is 24 hrs of one day here; the objective optimization function aims to calculate a minimum value of a total cost of the whole community within the cycle of optimal scheduling.

The total power of the community under the user-side energy storage sharing framework is expressed as:

$${P}_{t} = {\sum }_{r ∈ R} {P}_{r , t} \qquad ( 2 )$$

$${P}^{min} \leq {P}_{t} \leq {P}^{max} \qquad ( 3 )$$

where, P_{r,t} is a power of a r^{th} residence in the community, R is the number of residences in the community, and due to physical constraints, the power of the residence has an upper limit and a lower limit, and P^{max} and P^{min} are the upper limit and the lower limit of the power of the residence respectively;
the power of the residence under the user-side energy storage sharing framework may be expressed as:

$${P}_{r , t} = {\sum }_{d ∈ D} {P}_{d , t} - {P}_{r}^{i n} + {P}_{r}^{out} + {C}_{d , t} - {G}_{d , t} \qquad ( 4 )$$

$${P}_{r}^{min} \leq {P}_{r , t} \leq {P}_{r}^{max} \qquad ( 5 )$$

where, P_{d,t} is a power of a d^{th} electric appliance in the residence, including transferable loads, non-transferable loads, temperature control device loads and energy storage loads in the residence, and d∈D, wherein Dis a set of electric appliances; G_{d,t} is a generated power of the residence, which refers to a solar generated power here; C_{d,t} is a basic load of electric appliances other than the transferable loads, the non-transferable loads, the temperature control device loads and the energy storage loads in the residence; due to physical constraints, the power of the residence is limited by formula (5); Pᵣⁱⁿ is the input shared power, and Pᵣ^{out} is the output shared power.

The transferable loads in the residence are delayable loads which are flexibly adjustable during peak power demand, and the transferable loads include an electric vehicle EV, and a model of the electric vehicle EV is expressed as:

$${S}_{d , t + 1}^{e v} = {S}_{d , t}^{e v} + {P}_{d , t} Δ T \qquad ( 6 )$$

$${p}_{d o d} {S}_{max}^{e v} \leq {S}_{d , t}^{e v} \leq {S}_{max}^{e v} \qquad ( 7 )$$

$${e}_{d , t} {P}_{min}^{e v} \leq {P}_{d , t} \leq {e}_{d , t} {P}_{max}^{e v} \qquad ( 8 )$$

$${e}_{d , t} ∈ \{ 0 , 1 \} \qquad ( 9 )$$

$${S}_{d , 19}^{e v} \leq {p}_{st} {S}_{max}^{e v} \qquad ( 10 )$$

$${S}_{d , 7}^{e v} \geq {p}_{e d} {S}_{max}^{e v} \qquad ( 11 )$$

where, S_{d,t}^{ev} is the energy level of the electric vehicle EV, which is determined by a charge power per hour; formula (7) defines a charging constraint of the electric vehicle EV, p_{dod} is a deep discharge proportion of a battery, which is configured to ensure a good condition and life of the battery to prevent complete discharge of the battery; Sₘₐₓ^{ev} is a maximum capacity of the electric vehicle; formula (8) defines a constraint of the charge power; e_{d,t} is a variable, which is configured to determine whether the electric vehicle EV is charging or not; if e_{d,t} is 1, it indicates that the electric vehicle EV is charging; if e_{d,t} is 0, it indicates that the electric vehicle EV is not charging; pₛₜ and p_{ed} in formula (10) and formula (11) are state constraint proportions at specific times (19:00 and 7:00); it is stipulated that the electric vehicle EV starts to be charged when the capacity of the electric vehicle EV is less than or equal to pₛₜSₘₐₓ^{ev} and stops being charged when the capacity of the electric vehicle EV is greater than or equal to pₛₜSₘₐₓ^{ev}; it is specified that the electric vehicle EV should be charged from 19:00 to 7:00 of the next day, during which a charging state and number of electric vehicles EV are allowed to be adjusted according to power demand.

The non-transferable loads in the residence are loads that cannot be interrupted or stopped once started, and is expressed as:

$${P}_{d , t} = {\sum }_{k = 0}^{L - 1} {u}_{d , t - k} {\tilde{P}}_{d , k} \qquad ( 12 )$$

$${\sum }_{t = 0}^{T - L} {u}_{d , t} = 1 \qquad ( 13 )$$

$${u}_{d , t} ∈ \{ 0 , 1 \} \qquad ( 14 )$$

where, in formula (12), P_{d,t} is a total power consumed by all the non-interruptible loads, and L is a running window of the non-transferable loads, that is, the non-transferable loads are allowed to run at a power \tilde{P}_{d,k} in each time period k [0, L−1]; formula (13) and formula (18) indicate that the non-transferable loads are non-interruptible in specified running times; u_{d,t} is 0 or 1 and is configured as a constraint for determining whether the loads are running; if u_{d,t} is 1, it indicates that the loads are running; if u_{d,t} is 0, it indicates that loads are not running.

The temperature control device loads are loads of household appliances for controlling an indoor temperature, and a model of the temperature control device loads is expressed as:

$${ϑ}_{d , t + 1} = {a}_{d} {ϑ}_{d , t} + ( 1 - {a}_{d} ) ( {ϑ}_{d , t}^{e n v} - {ϑ}_{d , t}^{m} ) \qquad ( 15 )$$

$${a}_{d} = {e}^{- Δ T / {C}_{d} {R}_{d}} \qquad ( 16 )$$

$${ϑ}_{d , t}^{m} = {R}_{d} {P}_{d , t}^{tran} \qquad ( 17 )$$

$${P}_{d , t} = \frac{\vert {P}_{d , t}^{tran} \vert}{{η}_{tran}} \qquad ( 18 )$$

$${m}_{d , t} {P}_{d}^{min} \leq {P}_{d , t} \leq {m}_{d , t} {P}_{d}^{max} \qquad ( 19 )$$

$${m}_{d , t} ∈ \{ 0 , 1 \} \qquad ( 20 )$$

$${ϑ}_{d}^{min} \leq {ϑ}_{d , t} \leq {ϑ}_{d}^{max} \qquad ( 21 )$$

where, in formulas (15)-(21), formula (15) defines a temperature control model, wherein θ_{d,t} is an indoor temperature at the time t, which has a range defined by formula (21); a_{d} is a constant determined by formula (16), R_{d} is a heat resistance, indicating the degree of resistance against heat transfer of building materials; C_{d} is a heat capacity, indicating a heat storage capacity of the building materials; in formula (17), θ_{d,t}^{m} is a heat gain, specifically indicating heat provided by a temperature control device for an indoor space or heat absorbed by the temperature control device; P_{d,t}^{tran} is energy transfer efficiency, describing electric energy-to-heat energy efficiency of the temperature control device; in formula (18), ηₜᵣₐₙ is a performance coefficient, which is typically a parameter for describing the efficiency of a temperature control device system and is specifically described as a ratio of heat energy output by the system to electric energy consumed, and if the performance coefficient is greater than 1, it indicates that the system absorbs extra heat energy from the outside; P_{d,t} is power consumption of temperature control, indicating electric energy consumed by the temperature control device at the time t, formula (19) defines a range of P_{d,t}; m_{d,t} is a parameter configured to control the temperature control process; if m_{d,t} is 1, it indicates that temperature control is needed; if m_{d,t} is 0, it indicates that temperature control is not needed.

An energy storage device is responsible for obtaining electric energy from a power grid or solar energy and storing the electric energy; then, the electric energy stored in the energy storage device is used for supplying power to the loads, and a model of the energy storage device is expressed as:

$${S}_{d , t + 1} = {S}_{d , t} + ( {η}_{c h}^{e} {P}_{d , t}^{c h} - \frac{{P}_{d , t}^{d i s}}{{η}_{d i s}^{e}} ) Δ T \qquad ( 22 )$$

$${S}_{d}^{min} \leq {S}_{d , t} \leq {S}_{d}^{max} \qquad ( 23 )$$

$${P}_{d , t} = {P}_{d , t}^{c h} - {P}_{d , t}^{d i s} \qquad ( 24 )$$

$${s}_{t}^{c h} {P}_{d , t}^{ch , min} \leq {P}_{d , t}^{c h} \leq {s}_{t}^{c h} {P}_{d , t}^{ch , max} \qquad ( 25 )$$

$${s}_{t}^{d i s} {P}_{d , t}^{dis , min} \leq {P}_{d , t}^{d i s} \leq {s}_{t}^{d i s} {P}_{d , t}^{dis , max} \qquad ( 26 )$$

$${s}_{t}^{c h} + {s}_{t}^{d i s} \leq 1 \qquad ( 27 )$$

$${s}_{t}^{c h} , {s}_{t}^{d i s} ∈ \{ 0 , 1 \} \qquad ( 28 )$$

$${S}_{d , 24} = {η}_{s} {S}_{d}^{max} \qquad ( 29 )$$

where, formula (22) defines a SOC of the battery at the time t, which is expressed as S_{d,t}; η_{ch}^{e} and η_{dis}^{e} are variables which respectively denote charging efficiency and discharging efficiency, P_{d,t}^{ch} and P_{d,t}^{dis} denote a charge power and a discharge power; permissible ranges of the variables are defined by formula (23), formula (25) and formula (26); in addition, formula (24) is used for calculating a net power obtained by the residence through energy storage; to ensure proper running, formula (27) and formula (28) compulsorily specify that a charging process and a discharging process of energy storage should not be performed synchronously; specifically, sₜ^{ch} is a bivariate; when sₜ^{ch} is 1, it indicates that a charging behavior is started; when sₜ^{ch} is 0, it indicates that the charging behavior is not performed; sₜ^{dis} is a bivariate for controlling a discharging behavior; if sₜ^{dis} is 1, it indicates that the discharging behavior is started; when sₜ^{dis} is 1, it indicates that the discharging behavior is not performed; in addition, formula (29) sets a specific final SOC for a last period of time to allow charging and discharging in the next day, wherein ηₛ is a proportional parameter for starting the energy storage device in the next day; and the power S_{d,24} of the energy storage device at a last time on a day is specified to be equal to ηₛS_{d}^{max} to ensure that the energy storage device can be started in the next day.

An energy sharing model of the user-side energy storage sharing framework is expressed as:

$${\sum }_{r ∈ R} {P}_{r , t}^{i n} = {\sum }_{r ∈ R} {P}_{r , t}^{out} \qquad ( 30 )$$

$${P}_{r , t}^{i n} , {P}_{r , t}^{out} \geq {P}_{s h}^{min} \qquad ( 31 )$$

where, formula (30) defines a basic constraint of a capacity sharing process under the user-side energy storage sharing framework and ensures that total energy participating in household sharing matches total energy obtained by households; Pₛₕ^{min} in formula (31) is a minimum value of an energy sharing power, which is generally set to 0 and indicates that the energy sharing power should not be a negative value.

It should be noted that the sharing mechanism is implemented by a central control unit to realize capacity coordination and management. The unique feature of the user-side energy storage sharing framework allows users to effectively share and optimize energy storage resources to improve the overall efficiency and reliability of the system to the maximum extent. The central control unit plays a key role in making a sharing plan to realize efficient utilization of a shared capacity between participant households.

In some other implementations, a power energy scheduling optimization system for a user-side energy storage sharing framework comprises:
a modeling unit configured to store the electricity cost model of the whole community and the constraints in the power energy scheduling optimization method for a user-side energy storage sharing framework described above;
a calculation unit configured to resolve an optimal value of the electricity cost model by a MILP algorithm; and
a control unit configured to control loads of households in the community according to the optimal value obtained by the calculation unit. The control unit is a central control unit in the user-side energy storage sharing framework.

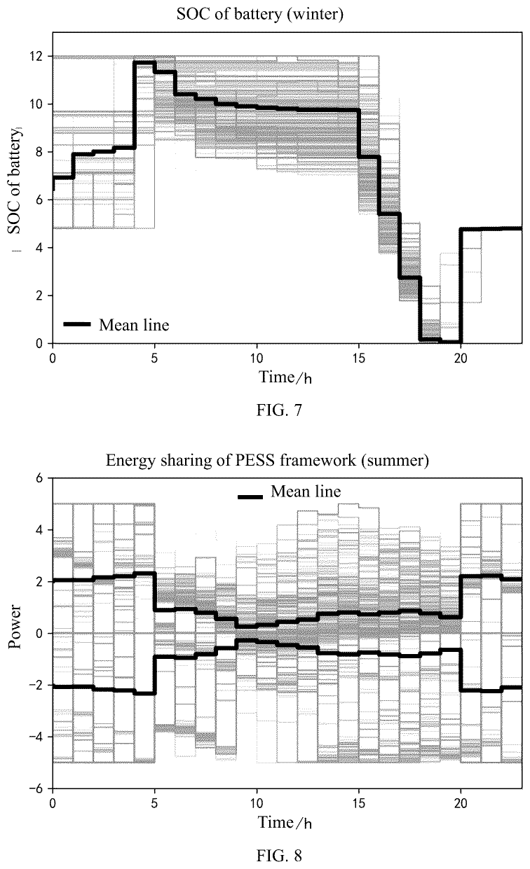

A conclusion is drawn by experimental simulation. The objective optimization function is resolved by the MILP algorithm, and under the user-side energy storage sharing framework, a charge curve, a discharge curve and a battery SOC curve are obtained taking a 12 kWh energy storage capacity into account, as shown in FIG. 2-FIG. 7.

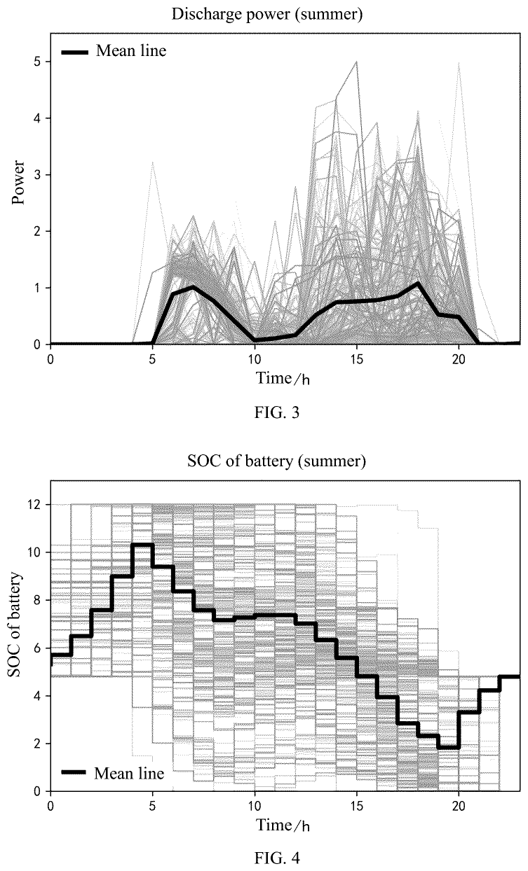

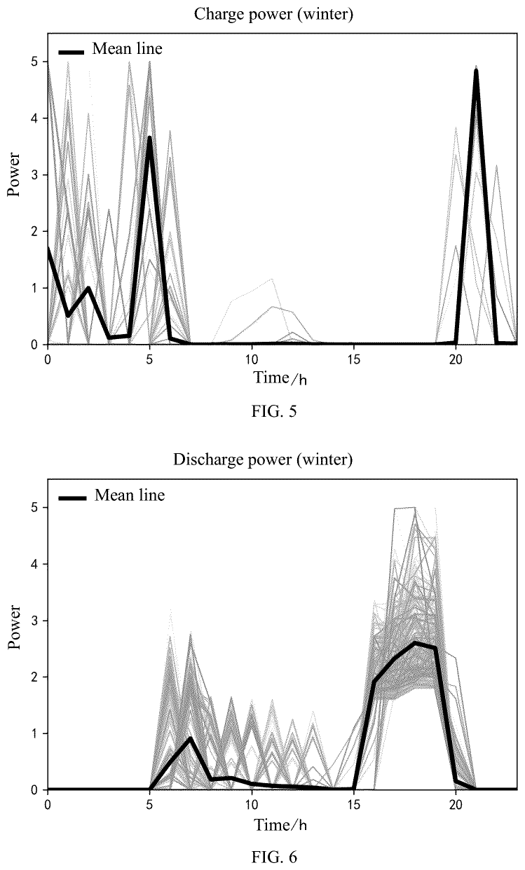

FIG. 2-FIG. 4 are diagrams of 300 users using 12 kWh energy storage in summer, and FIG. 5-FIG. 7 are diagrams of 300 users using the 12 kWh energy storage in winter. For the sake of clarity, the average behavior of the 300 users is indicated by the thick black line. First, it can be clearly seen, by observing FIG. 2 and FIG. 3, that the energy storage is charged mainly within 20:00-6:00 which corresponds to a non-peak electricity price period, and discharges within 12:00-20:00 which corresponds to a peak electricity price period. In addition to optimizing charge and discharge according to the electricity price, charge and discharge demands are determined mainly based on basic loads of users, charging requirements of electric vehicles and requirements of other loads. In FIG. 2 a charge power can be observed within 10:00-15:00, which is mainly because of the increase of the basic load in summer and the temperature control requirement within this period of time. FIG. 4 illustrates a curve of the stage of charge (SOC) of the battery changing with the charge/discharge curve. During charging, the SOC increases; during discharging, the SOC decreases.

In FIG. 5-FIG. 7, it can be seen that the trend in winter is different from that in summer which is because of the change of the electricity price and the load mode. For example, the charge curve in winter has multiple peaks within 0:00-6:00, which is because the temperature within this period of time is low and the power grid is used for satisfying heating requirements. However, the energy storage is still charged on the whole. It should be noted that the mean SOC curve in winter is steeper than the mean SOC curve in summer, indicating that the energy storage battery can be deeply charged and discharged more easily in winter, which may shorten the life of the battery.

In general, all these results obtained by observation indicate that the energy storage behavior of the battery changes with the change of the season, electricity prices and load requirements. It is of great importance to maximize the benefits of an energy storage system and guarantee the life of the battery by optimizing the charge and discharge mode according to these factors.

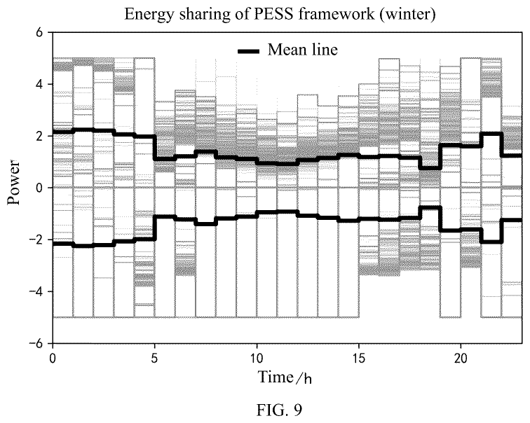

FIG. 8 and FIG. 9 illustrates capacity exchange curves of the user-side energy storage sharing framework in summer and winter, also taking into account the 12 kWh energy storage capacity. A capacity exchange mean of 300 users is indicated by the thick black line. It can be seen from FIG. 8 that in summer, the shared capacity is relatively high from 20:00 at night to 5:00 in the morning, and is relatively low in other times, which is because of the low electricity prices in this period of time. Therefore, residential customers tend to exchange electricity to satisfy requirements of specific large loads, thus reducing the overall operating cost of the system. In other periods of time, the shared capacity is mainly from solar power generation and energy stored in the energy storage device. However, due to the great power demand of users, the shared capacity is reduced. FIG. 9 illustrates a similar trend in winter in spite of some differences. It should be noted that the shared capacity is greater from 5:00 to 20:00, indicating that compared with capacity sharing in summer, capacity sharing in winter is more active.

According to the above observation results, the charge and discharge mode and the capacity sharing mode of the user-side energy storage sharing framework in summer and winter are both affected by the season, electricity prices and load demand. Such a flexible and intelligent operation brings economic benefits in multiple aspects:

Cost reduction: an energy storage system is charged in a low electricity price period at night and discharges in an electricity price peak period, thus reducing electricity costs of users; by reasonably optimizing the operation of the energy storage system, users can more effectively use the price difference of the power market to reduce costs.

Improvement of the efficiency of the power grid: the energy exchange of the energy storage sharing frame between a high demand period and a low electricity price period can balance loads and supply of a power system, thus reducing the overload risk of the power system and improving the stability and efficiency of the power grid.

Integration of renewable energy: the energy storage system can be intelligently integrated with renewable energy such as solar photovoltaic panels to store redundant renewable energy and discharge the stored renewable energy when needed to satisfy power requirements, thus increasing the utilization rate of the renewable energy.

Reduction of the dependency on traditional power: the energy storage sharing framework can reduce the dependency of users on traditional power sources, particularly power obtained by energy storage and sharing in low electricity price periods, thus reducing the demand for fossil fuel power and reducing carbon emission.

Management of the life of batteries: the life of batteries can be prolonged by intelligently optimizing the charge and discharge mode, thus reducing the battery replacement cost and improving the sustainability of the system.

Cooperation between users: the energy storage sharing framework encourages energy cooperation between users to allow users to exchange power according to requirements, thus promoting the cooperation and sharing spirit of the community.

To sum up, the energy storage sharing framework can bring multiple benefits in economy, environment and society. It not only can reduce energy costs of users, but also promotes wider application of renewable energy, thus improving the efficiency and stability of the power system and promoting energy cooperation between users and community construction. All these economical benefits make the energy storage sharing framework become an important part of sustainable energy in the future.

The implementations described above are merely preferred ones of the application. It should be pointed out that those ordinarily skilled in the art can make some transformations and improvements without departing from the inventive concept of the application, and all these transformations and improvements should fall within the protection scope of the application.

What is claimed is:

1. A power energy scheduling optimization method for a user-side energy storage sharing framework, comprising the following steps:
establishing an electricity cost model of a whole community as an objective optimization function, and setting constraints of the electricity cost model; and
resolving optimal values of variables in the electricity cost model, and controlling electric devices according to the optimal values.

2. The power energy scheduling optimization method for a user-side energy storage sharing framework according to claim 1, wherein the community includes multiple users, the users have different types of loads and are provided with solar power generation devices and battery energy storage devices, and capacity sharing is allowed between the battery energy storage devices of the users.

3. The power energy scheduling optimization method for a user-side energy storage sharing framework according to claim 2, wherein a formula of the objective optimization function is:
$$min {\sum }_{t ∈ T} {Π}_{t} Δ T {P}_{t} \qquad ( 1 )$$
where, Πₜ is a real-time electricity price, ΔT is a time interval, which is defined as 1 h here, Pₜ is a total power of the community at a time t, and T={1, . . . , 24} is a cycle of optimal scheduling, which is 24 hrs of one day here; the objective optimization function aims to calculate a minimum value of a total cost of the whole community within the cycle of optimal scheduling;
the total power of the community under the user-side energy storage sharing framework is expressed as:
$${P}_{t} = {\sum }_{r ∈ R} {P}_{r , t} \qquad ( 2 )$$
$${P}^{min} \leq {P}_{t} \leq {P}^{max} \qquad ( 3 )$$
where, P_{r,t} is a power of a r^{th} residence in the community, R is the number of residences in the community, and due to physical constraints, the power of the residence has an upper limit and a lower limit, and P^{max} and P^{min} are the upper limit and the lower limit of the power of the residence respectively;
the power of the residence under the user-side energy storage sharing framework is expressed as:
$${P}_{r , t} = {\sum }_{d ∈ D} {P}_{d , t} - {P}_{r}^{i n} + {P}_{r}^{out} + {C}_{d , t} - {G}_{d , t} \qquad ( 4 )$$
$${P}_{r}^{min} \leq {P}_{r , t} \leq {P}_{r}^{max} \qquad ( 5 )$$
where, P_{d,t} is a power of a d^{th} electric appliance in the residence, including transferable loads, non-transferable loads, temperature control device loads and energy storage loads in the residence, and d∈D, wherein D is a set of electric appliances; G_{d,t} is a generated power of the residence, which refers to a solar generated power here; C_{d,t} is a basic load of electric appliances other than the transferable loads, the non-transferable loads, the temperature control device loads and the energy storage loads in the residence; due to physical constraints, the power of the residence is limited by formula (5); Pᵣⁱⁿ is an input shared power, and Pᵣ^{out} is an output shared power.

4. The power energy scheduling optimization method for a user-side energy storage sharing framework according to claim 2, wherein the transferable loads in the residence are delayable loads which are flexibly adjustable during peak power demand, and the transferable loads include an electric vehicle EV, and a model of the electric vehicle EV is expressed as:
$${S}_{d , t + 1}^{e v} = {S}_{d , t}^{e v} + {P}_{d , t} Δ T \qquad ( 6 )$$
$${p}_{d o d} {S}_{max}^{e v} \leq {S}_{d , t}^{e v} \leq {S}_{max}^{e v} \qquad ( 7 )$$
$${e}_{d , t} {P}_{min}^{e v} \leq {P}_{d , t} \leq {e}_{d , t} {P}_{max}^{e v} \qquad ( 8 )$$
$${e}_{d , t} ∈ \{ 0 , 1 \} \qquad ( 9 )$$
$${S}_{d , 19}^{e v} \leq {p}_{st} {S}_{max}^{e v} \qquad ( 10 )$$
$${S}_{d , 7}^{e v} \geq {p}_{e d} {S}_{max}^{e v} \qquad ( 11 )$$
where, S_{d,t}^{ev} is an energy level of the electric vehicle EV, which is determined by a charge power per hour; formula (7) defines a charging constraint of the electric vehicle EV, p_{dod} is a deep discharge proportion of a battery, which is configured to ensure a good condition and life of the battery to prevent complete discharge of the battery; Sₘₐₓ^{ev} is a maximum capacity of the electric vehicle; formula (8) defines a constraint of the charge power; e_{d,t} is a variable, which is configured to determine whether the electric vehicle EV is charging or not; if e_{d,t} is 1, it indicates that the electric vehicle EV is charging; if e_{d,t} is 0, it indicates that the electric vehicle EV is not charging; pₛₜ and p_{ed} in formula (10) and formula (11) are state constraint proportions at specific times (19:00 and 7:00); it is stipulated that the electric vehicle EV starts to be charged when the capacity of the electric vehicle EV is less than or equal to pₛₜSₘₐₓ^{ev} and stops being charged when the capacity of the electric vehicle EV is greater than or equal to pₛₜSₘₐₓ^{ev}; it is specified that the electric vehicle EV should be charged from 19:00 to 7:00 of the next day, during which a charging state and number of electric vehicles EV are allowed to be adjusted according to power demand.

5. The power energy scheduling optimization method for a user-side energy storage sharing framework according to claim 2, wherein the non-transferable loads in the residence are loads that cannot be interrupted or stopped once started;
the non-transferable loads are expressed as:
$${P}_{d , t} = {\sum }_{k = 0}^{L - 1} {u}_{d , t - k} {\tilde{P}}_{d , k} \qquad ( 12 )$$
$${\sum }_{t = 0}^{T - L} {u}_{d , t} = 1 \qquad ( 13 )$$
$${u}_{d , t} ∈ \{ 0 , 1 \} \qquad ( 14 )$$
where, in formula (12), P_{d,t} is a total power consumed by all the non-interruptible loads, and L is a running window of the non-transferable loads, that is, the non-transferable loads are allowed to run at a power \tilde{P}_{d,k} in each time period k [0, L−1]; formula (13) and formula (18) indicate that the non-transferable loads are non-interruptible in specified running times; u_{d,t} is 0 or 1 and is configured as a constraint for determining whether the loads are running; if u_{d,t} is 1, it indicates that the loads are running; if u_{d,t} is 0, it indicates that loads are not running.

6. The power energy scheduling optimization method for a user-side energy storage sharing framework according to claim 2, wherein the temperature control device loads are loads of household appliances for controlling an indoor temperature, and a model of the temperature control device loads is expressed as:
$${ϑ}_{d , t + 1} = {a}_{d} {ϑ}_{d , t} + ( 1 - {a}_{d} ) ( {ϑ}_{d , t}^{e n v} - {ϑ}_{d , t}^{m} ) \qquad ( 15 )$$
$${a}_{d} = {e}^{- Δ T / {C}_{d} {R}_{d}} \qquad ( 16 )$$
$${ϑ}_{d , t}^{m} = {R}_{d} {P}_{d , t}^{tran} \qquad ( 17 )$$
$${P}_{d , t} = \frac{\vert {P}_{d , t}^{tran} \vert}{{η}_{tran}} \qquad ( 18 )$$
$${m}_{d , t} {P}_{d}^{min} \leq {P}_{d , t} \leq {m}_{d , t} {P}_{d}^{max} \qquad ( 19 )$$
$${m}_{d , t} ∈ \{ 0 , 1 \} \qquad ( 20 )$$
$${ϑ}_{d}^{min} \leq {ϑ}_{d , t} \leq {ϑ}_{d}^{max} \qquad ( 21 )$$
where, in formulas (15)-(21), formula (15) defines a temperature control model, wherein θ_{d,t} is an indoor temperature at the time t, which has a range defined by formula (21); a_{d} is a constant determined by formula (16), R_{d} is a heat resistance, indicating the degree of resistance against heat transfer of building materials; C_{d} is a heat capacity, indicating a heat storage capacity of the building materials; in formula (17), θ_{d,t}^{m} is a heat gain, specifically indicating heat provided by a temperature control device for an indoor space or heat absorbed by the temperature control device; P_{d,t}^{tran} is energy transfer efficiency, describing electric energy-to-heat energy efficiency of the temperature control device; in formula (18), ηₜᵣₐₙ is a performance coefficient, which is typically a parameter for describing the efficiency of a temperature control device system and is specifically described as a ratio of heat energy output by the system to electric energy consumed, and if the performance coefficient is greater than 1, it indicates that the system absorbs extra heat energy from the outside; P_{d,t} is power consumption of temperature control, indicating electric energy consumed by the temperature control device at the time t; formula (19) defines a range of P_{d,t}; m_{d,t} is a parameter configured to control the temperature control process; if m_{d,t} is 1, it indicates that temperature control is needed; if m_{d,t} is 0, it indicates that temperature control is not needed.

7. The power energy scheduling optimization method for a user-side energy storage sharing framework according to claim 2, wherein an energy storage device is responsible for obtaining electric energy from a power grid or solar energy and storing the electric energy; then, the electric energy stored in the energy storage device is used for supplying power to the loads, and a model of the energy storage device is expressed as:
$${S}_{d , t + 1} = {S}_{d , t} + ( {η}_{c h}^{e} {P}_{d , t}^{c h} - \frac{{P}_{d , t}^{d i s}}{{η}_{d i s}^{e}} ) Δ T \qquad ( 22 )$$
$${S}_{d}^{min} \leq {S}_{d , t} \leq {S}_{d}^{max} \qquad ( 23 )$$
$${P}_{d , t} = {P}_{d , t}^{c h} - {P}_{d , t}^{d i s} \qquad ( 24 )$$
$${s}_{t}^{c h} {P}_{d , t}^{c h ,} \leq {P}_{d , t}^{c h} \leq {s}_{t}^{c h} {P}_{d , t}^{ch , max} \qquad ( 25 )$$
$${s}_{t}^{d i s} {P}_{d , t}^{dis , min} \leq {P}_{d , t}^{d i s} \leq {s}_{t}^{d i s} {P}_{d , t}^{dis , max} \qquad ( 26 )$$
$${s}_{t}^{c h} + {s}_{t}^{d i s} \leq 1 \qquad ( 27 )$$
$${s}_{t}^{c h} , {s}_{t}^{d i s} ∈ \{ 0 , 1 \} \qquad ( 28 )$$
$${S}_{d , 24} = {η}_{s} {S}_{d}^{max} \qquad ( 29 )$$
where, formula (22) defines a SOC of the battery at the time t, which is expressed as S_{d,t}; η_{ch}^{e} and η_{dis}^{e} are variables which respectively denote charging efficiency and discharging efficiency, P_{d,t}^{ch} and P_{d,t}^{dis} denote a charge power and a discharge power; permissible ranges of the variables are defined by formula (23), formula (25) and formula (26); in addition, formula (24) is used for calculating a net power obtained by the residence through energy storage; to ensure proper running, formula (27) and formula (28) compulsorily specify that a charging process and a discharging process of energy storage should not be performed synchronously; specifically, sₜ^{ch} is a bivariate; when sₜ^{ch} is 1, it indicates that a charging behavior is started; when sₜ^{ch} is 0, it indicates that the charging behavior is not performed; sₜ^{dis} is a bivariate for controlling a discharging behavior; if sₜ^{dis} is 1, it indicates that the discharging behavior is started; when sₜ^{dis} is 1, it indicates that the discharging behavior is not performed; in addition, formula (29) sets a specific final SOC for a last period of time to allow charging and discharging in the next day, wherein ηₛ is a proportional parameter for starting the energy storage device in the next day; and the power S_{d,24} of the energy storage device at a last time on a day is specified to be equal to ηₛS_{d}^{max} to ensure that the energy storage device can be started in the next day.

8. The power energy scheduling optimization method for a user-side energy storage sharing framework according to claim 2, wherein an energy sharing model of the user-side energy storage sharing framework is expressed as:
$${\sum }_{r ∈ R} {P}_{r , t}^{i n} = {\sum }_{r ∈ R} {P}_{r , t}^{out} \qquad ( 30 )$$
$${P}_{r , t}^{i n} , {P}_{r , t}^{out} \geq {P}_{s h}^{min} \qquad ( 31 )$$
where, formula (30) defines a basic constraint of a capacity sharing process under the user-side energy storage sharing framework and ensures that total energy participating in household sharing matches total energy obtained by households; Pₛₕ^{min} in formula (31) is a minimum value of an energy sharing power, which is generally set to 0 and indicates that the energy sharing power should not be a negative value.

9. The power energy scheduling optimization method for a user-side energy storage sharing framework according to claim 2, wherein the objective optimization function is resolved by a MILP algorithm.

10. A power energy scheduling optimization system for a user-side energy storage sharing framework, comprising
a modeling unit configured to store the electricity cost model of the whole community and the constraints in the power energy scheduling optimization method for a user-side energy storage sharing framework according to claim 1;
a calculation unit configured to resolve an optimal value of the electricity cost model by a MILP algorithm; and
a control unit configured to control loads of households in the community according to the optimal value obtained by the calculation unit.
